(19) United States
(12) Patent Application Publication
(10) Pub. No.: US 2012/0030770 A1
(43) Pub. Date: Feb. 2, 2012

(54) Assisted tuning of capacitive monitoring components

(76) Inventors: Jameel Abdul Ahed, Cape Coral, FL (US); Siddhartha Eluppai Srivatsan, Cape Coral, FL (US)

(21) Appl. No.: 13/136,429

(22) Filed: Aug. 1, 2011

Related U.S. Application Data
(60) Provisional application No. 61/400,627, filed on Jul. 30, 2010.
(60) Provisional application No. 61/400,628, filed on Jul. 30, 2010.
(60) Provisional application No. 61/403,450, filed on Sep. 15, 2010.
(60) Provisional application No. 61/455,996, filed on Oct. 29, 2010.

(51) Int. Cl. H04L 9/00; G06F 19/00

(52) U.S. Cl. 726/26; 702/85

(57) ABSTRACT

Assisted tuning of a capacitive monitoring component via a system, method, and a computer program product. Via a system, a software program can be adapted to execute on a computer communicatively connected to the capacitive monitoring component, with the program being further adapted to allow a user to selectively manipulate configuration parameters of the capacitive monitoring component as the user tests operation of the capacitive monitoring component to determine and select a plurality of desired parameters. A parameter data set can include the plurality of desired parameters, and be stored on a tangible medium of expression.

### CROSS-REFERENCE TO RELATED APPLICATIONS

The present disclosure is related to, claims the priority benefit of, and incorporates by reference in their entireties, the following applications: U.S. Provisional Patent Application 61/400,627, entitled “Assisted Tuning of Capacitive Monitoring Components,” and filed on Jul. 30, 2010 by Ahed et al.; U.S. Provisional Patent Application 61/400,628, entitled “Aluminum-based Capacitive Monitoring Component,” and filed on Jul. 30, 2010 by Ahed et al.; U.S. Provisional Patent Application 61/403,450, entitled “Assisted Tuning of Capacitive Monitoring Component,” and filed on Sep. 15, 2010 by Ahed et al.; U.S. Provisional Patent Application 61/455,996 entitled “Electrical Tail Adapter,” and filed on Oct. 29, 2010 by Ahed; and US patent application 13/135,318 entitled “Edge Lighting for a Capacitive Sensing Device,” filed on Jun. 30, 2011 by Ahed et al., which claimed the priority of U.S. Provisional Patent Application 61/398,756 entitled “Edge Lighting in Capacitive Touch Environment,” and filed on Jun. 30, 2010 by Ahed et al. and U.S. Provisional Patent Application 61/404,460 entitled “User Interface Lighting System and Method,” and filed on Oct. 4, 2010 by Ahed.

### FIELD OF THE INVENTION

The present invention relates to capacitive monitoring devices, and more specifically, assisted tuning of the same.

### BACKGROUND OF THE INVENTION

Capacitive monitoring devices can monitor capacitive charges in pads for capacitive changes. These changes represent logical states representing the introduction and/or removal of objects having conductive or dielectric properties from an area or areas being monitored for such introductions and/or removals.

### BRIEF SUMMARY OF THE INVENTION

It is, therefore, an object of the present invention to provide assisted tuning of capacitive monitoring components.

The present invention can be embodied in a system for effectuating assisted tuning of a capacitive monitoring component, a method of effectuating assisted tuning of capacitive monitoring components, and a computer readable medium embodying such a method.

In an exemplary embodiment, a system for effectuating assisted tuning of a capacitive monitoring component can include a software program adapted to execute on a computer communicatively connected to the capacitive monitoring component, with the program being further adapted to allow a user to selectively manipulate configuration parameters of the capacitive monitoring component as the user tests operation of the capacitive monitoring component to determine and select a plurality of desired parameters; and a parameter data set, including the plurality of desired parameters, and being stored on a tangible medium of expression.

In an exemplary aspect of the present invention, the parameter data set can include at least two data instances respectively representing two of a current supply, a noise filtering algorithm, a reference voltage, a reduced voltage value; a tolerance value, a threshold value; a communication protocol, a data file name, a data file location, a function mapping, and a data type definition.

In another exemplary aspect of the present invention, the capacitive monitoring component can be installed in a macro system as the user tests operation of the capacitive monitoring component.

In a further exemplary aspect of the present invention, the computer can be communicatively connected to the capacitive monitoring component via a wireless communication channel.

In still a further exemplary aspect of the present invention, at least a portion of communication data communicated between the program and the capacitive monitoring component can be cryptographically secured.

In still yet a further exemplary aspect of the present invention, at least a portion of communication data communicated between the program and the capacitive monitoring component can be cryptographically secured on the computer before transmission to the capacitive monitoring component.

In still yet another exemplary aspect of the present invention, at least a portion of communication data communicated between the program and the capacitive monitoring component can be cryptographically secured on the capacitive monitoring component after reception from the computer.

In still yet a further exemplary aspect of the present invention, the parameter data set can be cryptographically stored on the tangible medium of expression.

Additional exemplary embodiments include a method of effectuating assisted tuning of a capacitive monitoring component, and a computer program product comprising a computer readable storage medium containing program instructions, where the program instructions, when executed on a computer in response to a request by a user to effectuate assisted tuning of a capacitive monitoring component, cause the computer to perform steps, both of which being consistent with the exemplary system and related aspects disclosed herein.

### BRIEF DESCRIPTION OF THE DRAWINGS

The present invention is illustrated by way of example, and not in limitation, in the figures of the accompanying drawings, in which:

FIG. 1 illustrates, according to the present invention, an exemplary system for effectuating assisted tuning of a capacitive monitoring component.

FIG. 2 illustrates, according to the present invention, an overview exemplary method according to the present invention, with the method of effectuating assisted tuning of a capacitive monitoring component.

### DETAILED DESCRIPTION OF THE INVENTION

The invention will now be described in more detail by way of example with reference to the embodiments shown in the accompanying figures. It should be kept in mind that the following described embodiments are only presented by way of example and should not be construed as limiting the inventive concept to any particular physical configuration, shape, size, or order.

An exemplary environment of the present invention includes capacitive monitoring, which can be used, for example and not in limitation, for user interfaces and proximity detection.

In the former case, capacitive touch interfaces can provide an input-based user interface. A user can touch a monitored area representative of a logical state, which can be detected via a change in capacitance and thereafter communicated to a macro system, such as a computer, for example and not in limitation. In the latter case, an area can be monitored for changes in capacitance, which represent a logic state (e.g., a person's body is or is not within a monitored area, or moves away from a monitored area) and thereafter be communicated to a macro system. Common to these cases, one or more conductive pads can be provided, with the pads being charged so as to have a measurable capacitance. These capacitances are monitored for changes by an electronic system, which can generally include a microcontroller for orchestrating the charging, monitoring, and reporting. In any event, configuration parameters are data values representing, either directly or indirectly, particular aspects of the charging, monitoring, and/or reporting of such an electronic system. Therefore, a capacitive monitoring component can include at least one pad and an electronic system for charging, monitoring, and reporting functions.

For example and not in limitation, configuration parameters can represent one or more of the following: particular current supplies provided to each pad; one or more noise filtering algorithms including respective order of operation; one or more reference voltages (which may optionally be averages) for representing non-activation; reduced voltage values (which may also optionally be averages) for representing activation; one or more tolerance values for providing leeway for detecting activations (e.g., a percentage change in capacitance for a logical state change); one or more threshold values (e.g., a minimum/maximum voltage for a logical state change); one or more types of communication protocols, such as, for example and not in limitation, Universal Serial Bus, RS232, SPI, I²C, BLUETOOTH, 802.11b, 802.11a, 802.11g, Infrared, RF (radio frequency), etc.; one or more data file names and/or locations; function mapping data (e.g., which functions are mapped to particular logical states); and the specific data provided based on the logical states (e.g., on activation, on deactivation following activation [which can include timing requirements for such a logical state], on deactivation [which can include timing requirements for such a logical state], etc.). It should be noted that the above parameters can be representative of one, a subset, or all of the pads; and further, can be provided in multiple sets to allow configurations on a pad-by-pad basis, as well as multiple configurations for each pad to allow multiple operating modes.

One highly advantageous aspect of the present invention is the provisioning of the ability to test and configure a capacitive monitoring component that is physically positioned in an intended use, such as installed within a macro system, which can be, for example and not in limitation, a computer, a mobile phone, a medical imaging machine, a personal digital assistant, a consumer appliance (such as a stove, dishwasher, microwave oven, etc.), or other system that can employ a capacitive monitoring component. Due to plural unknown and untested environmental factors, such as electronic interference, electromagnetic fields, physical configuration of other components having effects on capacitance, power supply noise, etc., a capacitive monitoring component generically configured and tuned when not so positioned, may fail, in whole or in part, due to these environmental factors. Such failures can require dislodging or otherwise disconnecting or uninstalling the capacitive monitoring component for one or more additional tuning or configuration attempts in a trial and error manner that can require repeated iterations, which is highly inefficient and potentially inaccurate.

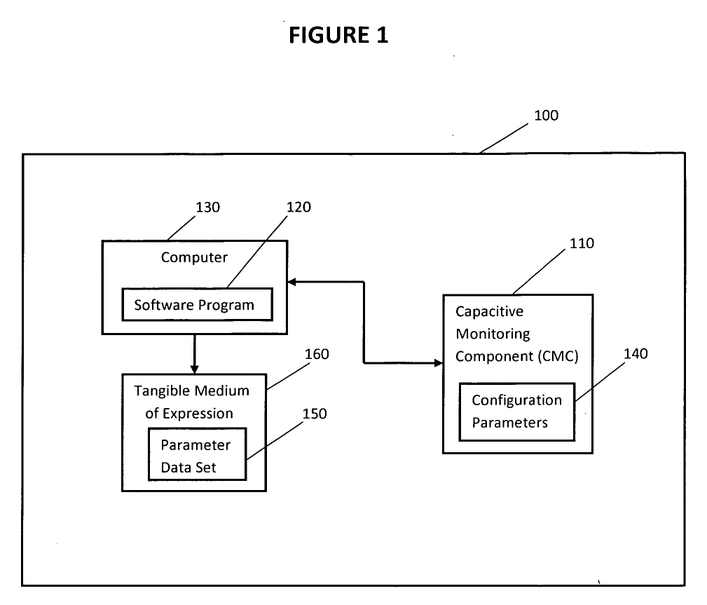

Now referring to FIG. 1, illustrated thereby is an exemplary system 100 for effectuating assisted tuning of a capacitive monitoring component 110 (“CMC”). System 100 can include a software program 120 adapted to execute on a computer 130 communicatively connected to CMC 110. Computer program 120 is further adapted to allow a user (not shown) to selectively manipulate configuration parameters 140 stored on CMC 110 as the user tests operation of the CMC to determine and select a plurality of desired parameters, which are then stored in parameter data set 150 on a tangible medium of expression 160. It should be noted that configuration parameters

In an exemplary aspect of the present invention, computer program 110 can be adapted to output parameter data set 140, which can then be provided for production or other purposes. Notably, computer program 110 can be adapted to display or otherwise communicate parameter data set 140 for a user to transcribe or otherwise communicate for production or other purposes.

According to the present invention, a tangible medium of expression includes paper and computer readable mediums, and notably, hereby expressly exceeds the scope of that defined by the Copyright Laws of the United States. Therefore, such a medium of expression includes even slightly stable mediums that can be reproduced or otherwise perceived or communicated, such as a user's memory, as when a user memorizes and then communicates parameter data set 140 verbally. Notably, the present invention is intended to cover subsequent transcriptions of parameter data set 140 by another party, such as when a user verbally communicates data set 140 via telephone or otherwise, and a subsequent party transcribes the same to written or digital form, as with data entry, for example and not in limitation.

According to the present invention, as described above, configuration parameters can represent one or more of the following: particular current supplies provided to one or more pads; one or more noise filtering algorithms, optionally including respective order of operation; one or more reference voltages (which may optionally be averages) for representing non-activation; one or more reduced voltage values (which may also optionally be averages) for representing activation; one or more tolerance values for providing leeway in detecting activations or deactivations (e.g., a percentage change in capacitance for a logical state change); one or more threshold values (e.g., a minimum/maximum voltage for a logical state change); one or more types of communication protocols, such as, for example and not in limitation, Universal Serial Bus, RS232, SPI, I²C, BLUETOOTH, 802.11b, 802.11a, 802.11g, Infrared, RF (radio frequency), etc.; one or more data file names and/or locations, such as with function-mapping for example and not in limitation; function mapping data (e.g., which logical states are mapped to particular functions [such as, audio files, tactile feedback and data ancillary thereto, lighting effects, etc.]); and particular data provided based on logical states (e.g., on activation, on deactivation following activation [which can include timing requirements for such a logical state], on deactivation [which can include timing requirements for such a logical state], etc.). It should be noted that the above parameters can be representative of one, a subset, or all of the pads; and further, can be provided in multiple sets to allow configurations on a pad-by-pad basis, as well as multiple configurations for one or more pads to allow multiple operating modes of CMC 110.

In a further exemplary aspect of the present invention, configuration parameters can be stored on the CMC 110, or on a computer readable medium, such as one or more memory modules, registers, etc., which may or may not be contained within a microcontroller.

According to the present invention, computer 130 can be communicatively connected to CMC 110 in either a hardwired or wireless manner. Further, such a connection can be made directly or indirectly (through a macro-interface via a macro system, for example and not in limitation) with CMC 110. Notably, where CMC 110 is positioned in an intended, yet complicated manner, such as “deeply” within a physically complicated macro system or within a sealed or underwater system, for example and not in limitation, communication in a wireless manner can be highly advantageous.

In another exemplary aspect of the present invention, at least a portion of the communication data communicated between software program 120 and CMC 110 can be cryptographically secured, such that the communications are protected from tampering, protected from unauthorized access, and/or confirmably recorded. Therefore, one or more cryptographic schemes may be employed to achieve one or more of these goals, such as symmetric and/or asymmetric cryptography, data translation, data indexing, digital signing, etc. To be clear, the present invention as described is intended to cover very weak to very strong cryptographic measures, and the particular cryptographic protocol(s) selected will be an apparent design choice based on the circumstances. Further, cryptographic measures can be employed via one or more of the following: via software program 120, via the communication channel, via CMC 110, and via an overall transparent cryptographic scheme (such as data translation and/or indexing, for example and not in limitation).

Further, parameter data set 140 can be cryptographically stored on the tangible medium of expression in any manner described above, or functionally consistent therewith or herein.

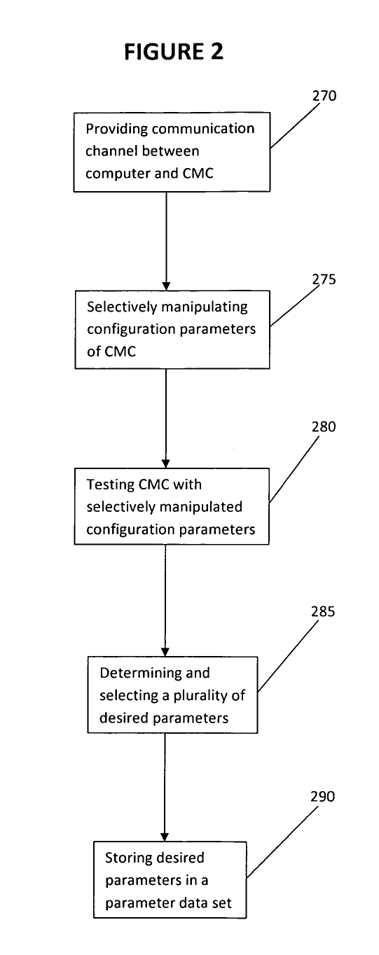

FIG. 2 illustrates an overview exemplary method according to the present invention, with the method including the following steps: providing a communication channel between a computer and a CMC (block 270); selectively manipulating configuration parameters of the CMC (block 275); testing the CMC with the selectively manipulated configuration parameters (block 280); determining and selecting a plurality of desired parameters (block 285); and storing the desired parameters in a parameter data set (block 290). Accordingly, the present invention provides interactive testing to determine desired parameters in a highly efficient manner and resulting in a parameter data set, which can be utilized for subsequent configuration of additional units of CMCs.

Further, methods according to the present invention can be similarly provided as with this description regarding systems. Likewise, such methods can be embodied in computer program products.

It will be apparent to one of ordinary skill in the art that the manner of making and using the claimed invention has been adequately disclosed in the above-written description of the exemplary embodiments and aspects taken together with the drawings.

It should be understood, however, that the invention is not necessarily limited to the specific embodiments, aspects, arrangement, and components shown and described above, but may be susceptible to numerous variations within the scope of the invention.

Accordingly, the specification and drawings are to be regarded in an illustrative and enabling, rather than a restrictive, sense.

Therefore, it will be understood that the above description of the embodiments of the present invention are susceptible to various modifications, changes, and adaptations, and the same are intended to be comprehended within the meaning and range of equivalents of the appended claims.

Therefore, we claim:

1. A system for effectuating assisted tuning of a capacitive monitoring component, comprising:
a software program adapted to execute on a computer communicatively connected to the capacitive monitoring component, said program further adapted to allow a user to selectively manipulate configuration parameters of the capacitive monitoring component as the user tests operation of the capacitive monitoring component to determine and select a plurality of desired parameters; and
a parameter data set, including the plurality of desired parameters, and stored on a tangible medium of expression.

2. The system of claim 1, wherein said parameter data set includes at least two data instances respectively representing two of a current supply, a noise filtering algorithm, a reference voltage, a reduced voltage value; a tolerance value, a threshold value; a communication protocol, a data file name, a data file location, a function mapping, and a data type definition.

3. The system of claim 1, wherein the capacitive monitoring component is installed in a macro system when the user tests operation of the capacitive monitoring component.

4. The system of claim 1, wherein the computer is communicatively connected to the capacitive monitoring component via a wireless communication channel.

5. The system of claim 1, wherein the tangible medium of expression is a computer readable medium.

6. The system of claim 1, wherein at least a portion of communication data communicated between the computer and the capacitive monitoring component is cryptographically secured.

7. The system of claim 1, wherein at least a portion of communication data communicated between the computer and the capacitive monitoring component is cryptographically secured on the computer before transmission to the capacitive monitoring component.

8. The system of claim 1, wherein at least a portion of communication data communicated between the computer and the capacitive monitoring component is cryptographically secured on the capacitive monitoring component after reception from the computer.

9. The system of claim 1, wherein said parameter data set is cryptographically stored on the tangible medium of expression.

10. The system of claim 1, wherein at least one of at least a portion of said parameter data set and at least a portion of communication data communicated between the computer and the capacitive monitoring component is cryptographically stored on the capacitive monitoring component.

11. A method of effectuating assisted tuning of a capacitive monitoring component, comprising steps of:
providing a communication channel between a computer and the capacitive monitoring component;
selectively manipulating, via computer software executing on the computer, configuration parameters of the capacitive monitoring component;
testing the capacitive monitoring component with the selectively manipulated configuration parameters;
determining and selecting desired parameters based on said step of testing; and
storing the desired parameters in a parameter data set on a tangible medium of expression.

12. The method of claim 11, wherein said parameter data set includes at least two data instances respectively representing two of a current supply, a noise filtering algorithm, a reference voltage, a reduced voltage value; a tolerance value, a threshold value; a communication protocol, a data file name, a data file location, a function mapping, and a data type definition.

13. The method of claim 11, wherein the capacitive monitoring component is installed in a macro system during said testing.

14. The method of claim 11, wherein the computer is communicatively connected to the capacitive monitoring component via a wireless communication channel.

15. The method of claim 11, wherein the tangible medium of expression is a computer readable medium.

16. The method of claim 11, wherein at least a portion of communication data communicated between the computer and the capacitive monitoring component is cryptographically secured.

17. The method of claim 11, wherein at least a portion of communication data communicated between the computer and the capacitive monitoring component is cryptographically secured on the computer before transmission to the capacitive monitoring component.

18. The method of claim 11, wherein at least a portion of communication data communicated between the computer and the capacitive monitoring component is cryptographically secured on the capacitive monitoring component after reception from the computer.

19. The method of claim 11, wherein the parameter data set is cryptographically stored on the tangible medium of expression.

20. The method of claim 11, wherein at least one of at least a portion of the parameter data set and at least a portion of communication data communicated between the computer and the capacitive monitoring component is cryptographically stored on the capacitive monitoring component.

21. A computer program product comprising a computer readable storage medium containing program instructions, where the program instructions, when executed on a computer in response to a request by a user to effectuate assisted tuning of a capacitive monitoring component, cause the computer to:
establish a communication channel between the computer and the capacitive monitoring component;
selectively manipulate configuration parameters of the capacitive monitoring component;
test the capacitive monitoring component with the selectively manipulated configuration parameters;
determine and select desired parameters; and
store the desired parameters in a parameter data set on a tangible medium of expression.

22. The computer program product of claim 21, wherein the parameter data set includes at least two data instances respectively representing two of a current supply, a noise filtering algorithm, a reference voltage, a reduced voltage value; a tolerance value, a threshold value; a communication protocol, a data file name, a data file location, a function mapping, and a data type definition.

23. The computer program product of claim 21, wherein the capacitive monitoring component is installed in a macro system during said caused test.

24. The computer program product of claim 21, wherein the computer is communicatively connected to the capacitive monitoring component via a wireless communication channel.

25. The computer program product of claim 21, wherein the tangible medium of expression is a computer readable medium.

26. The computer program product of claim 21, wherein at least a portion of communication data communicated between the computer and the capacitive monitoring component is cryptographically secured.

27. The computer program product of claim 21, wherein at least a portion of communication data communicated between the computer and the capacitive monitoring component is cryptographically secured on the computer before transmission to the capacitive monitoring component.

28. The computer program product of claim 21, wherein at least a portion of communication data communicated between the computer and the capacitive monitoring component is cryptographically secured on the capacitive monitoring component after reception from the computer.

29. The computer program product of claim 21, wherein the parameter data set is cryptographically stored on the tangible medium of expression.

30. The computer program product of claim 21, wherein at least one of at least a portion of the parameter data set and at least a portion of communication data communicated between the computer and the capacitive monitoring component is cryptographically stored on the capacitive monitoring component.
